(19) United States
(12) Patent Application Publication
(10) Pub. No.: US 2016/0292274 A1
(43) Pub. Date: Oct. 6, 2016

(54) OPERATION METHOD OF NODE CONSIDERING PACKET CHARACTERISTIC IN CONTENT-CENTERED NETWORK AND NODE

(71) Applicant: Samsung Electronics Co., Ltd., Suwon-si Gyeonggi-do (KR)

(72) Inventors: Joong Hong PARK, Suwon-si (KR); Jae Hoon KIM, Suwon-si (KR); Myeong Wuk JANG, Suwon-si (KR)

(73) Assignee: Samsung Electronics Co., Ltd., Suwon-si (KR)

(21) Appl. No.: 15/033,982

(22) PCT Filed: Jul. 16, 2014
(86) PCT No.: PCT/KR2014/006412

§ 371 Date: May 3, 2016

(30) Foreign Application Priority Data
Nov. 6, 2013 (KR) 10-2013-0134072

(51) Int. Cl. G06F 17/30; H04L 29/08; H04L 29/06

(52) U.S. Cl. CPC G06F 17/30864; H04L 69/22; H04L 67/2842

(57) ABSTRACT

A node includes a content table configured to store a segment of a content in a memory, a controller configured to select a search algorithm, from among plural search algorithms, to search for a content requested by a packet received from another node, based on a determined characteristic of the packet received from the other node, and a searcher configured to search contents stored in the content table for at least one portion of a content name of the content for the packet using the selected search algorithm.

### CROSS -REFERENCE TO RELATED APPLICATIONS

This application is a U.S. national stage application of International Application No. PCT/KR2014/006412 filed on Jul. 16, 2014, which claims the benefit of Korean Patent Application No. 10-2013-0134072 filed on Nov. 6, 2013, in the Korean Intellectual Property Office, the entire disclosures of which are incorporated herein by reference for all purposes.

### BACKGROUND

1. Field

The following description relates to a node and method of considering packet characteristics in a content centric network (CCN).

2. Description of Related Art

A content centric network (CCN) supports an effective distribution of contents by storing segments of the contents using a content cache of each node. In a CCN network, content may be directly addressable, and routable. For example, while IP based information requests may be addressable based on IP addressing, CCN content may be directly addressable and routable. More particularly, a node may not receive a desired content directly from a source every time. However, the node may receive the content from an intermediate node storing the content on a routing path. Thus, in the CCN, a node, for example, a content source or a server, may not be inundated with requests for the content and crowding in a core network may be reduced.

For the effective distribution of contents, each node among numerous nodes present on the routing path may search all content segments in the cache, which in response to a request for a content segment, for the content segment. Here, despite the application of an effective search algorithm, an overall transmission performance may deteriorate due to processing overhead when numerous nodes on the routing path need to search all the content segments in the respective caches in response to a request for the content segment.

### SUMMARY

In one general aspect, there is provided a node including a content cache including a content table to store at least one segment of a content, a controller to determine a search algorithm based on a characteristic of a packet received from another node, and a searcher to search contents stored in the content table using at least one portion of a content name based on the determined search algorithm.

The controller may determine which of a data packet and a control packet corresponds to the characteristic of the packet, and determine the search algorithm based on a result of the determining.

The controller may analyze the packet, extract a segment number of the content requested by the packet, and determine which of the data packet and the control packet corresponds to the characteristic of the packet based on the segment number.

The controller may extract a command indicator from the packet and determine which of the data packet, and the control packet corresponds to the characteristic of the packet based on the command indicator.

The controller may extract information from a header of the packet and determine which of the data packet, and the control packet corresponds to the characteristic of the packet based on the extracted information.

When the packet is determined to be the control packet, the controller may determine the search algorithm to be a binary search algorithm based on a partial match to the content name.

When the packet is determined to be the data packet, the controller may determine the search algorithm to be a hash search algorithm based on a full match to the content name.

The searcher may include a binary search module and a hash search module. The binary search module may search for the content using the at least one portion of the content name based on the binary search algorithm, and the hash search module may search for the content using a full content name based on the hash search algorithm.

A number of components in a name of the content to be searched for using the at least one portion of the content name based on the binary search algorithm may be preset.

In another general aspect, there is provided an operation method of a node including receiving an interest packet from another node, determining, based on a characteristic of the interest packet, whether a partial match to a content name is required, and searching for a matched content after selecting one of a binary search algorithm and a hash search algorithm, based on a result of the determining.

The determining may include determining whether the interest packet requires the partial match to the content name based on the content name in the interest packet or header information of the interest packet.

The searching may include selecting the binary search algorithm when the interest packet is determined to require the partial match to the content name and searching for the matched content based on the binary search algorithm.

The searching may include selecting the hash search algorithm when the interest packet is determined to require a full match to the content name, and searching for the matched content based on the hash search algorithm.

The searching based on the hash search algorithm may include performing a hash function by determining the content name to be a key value, obtaining an index value of a hash table based on a result of the performing, and searching for the matched content based on the index value.

The operation method of the node may further include forwarding a retrieved content after the searching.

In still another general aspect, there is provided an operation method of a node including receiving a content packet from another node, determining whether a segment of the content packet is required for a partial matching of a content name, and adding the segment to at least one of a binary search list and a hash table based on a result of the determining.

The determining may include determining whether the segment is required for the partial match to the content name based on the content name in the content packet or header information of the content packet.

When the segment is determined to be required for the partial match to the content name, the adding may include adding the segment to the binary search list and the hash table.

When the segment is determined not to be required for the partial match to the content name, the adding may include adding the segment to the hash table.

### BRIEF DESCRIPTION OF DRAWINGS

FIG. 1 illustrates an example of a process of forwarding a content in a content centric network (CCN).

FIG. 2 is a diagram illustrating an example of a structure of a content cache of a node.

FIG. 3 illustrates an example of a structure of a skip list used for a binary search algorithm.

FIG. 4 illustrates an example of a method of searching a skip list based on a binary search algorithm.

FIG. 5 illustrates an example of a hash search algorithm.

FIG. 6 is a flowchart illustrating an example of a node processing method for an interest packet.

FIG. 7 is a flowchart illustrating an example of a node processing method for a content packet in a CCN.

### DETAILED DESCRIPTION

Reference will now be made in detail to embodiments, of which are illustrated in the accompanying drawings, wherein like reference numerals refer to the like elements throughout. The features described herein may be embodied in different forms, and are not to be construed as being limited to the examples described herein.

A node described herein may include consumer devices such as a user terminal including a smartphone, a smart television (TV), a personal computer (PC), a laptop computer, and a robot cleaner, and networking devices such as an access point and a router. A content centric network (CCN) is an example of information centric networking commonly indicating various networking methods that brings a content based on a content name. Descriptions herein may be also applied to an information centric network, along with the CCN.

Also, a content requester described herein may refer to a communication device, or a node requesting a content or a streaming content in the CCN. A content provider described herein may refer to a communication device or a node providing the content or the streaming content requested by such a content requester, and may include a content creator, for example, a content publisher, and an intermediate node possessing at least a portion of the content among intermediate nodes present on a path through which a content request packet is forwarded, or any combination of the same.

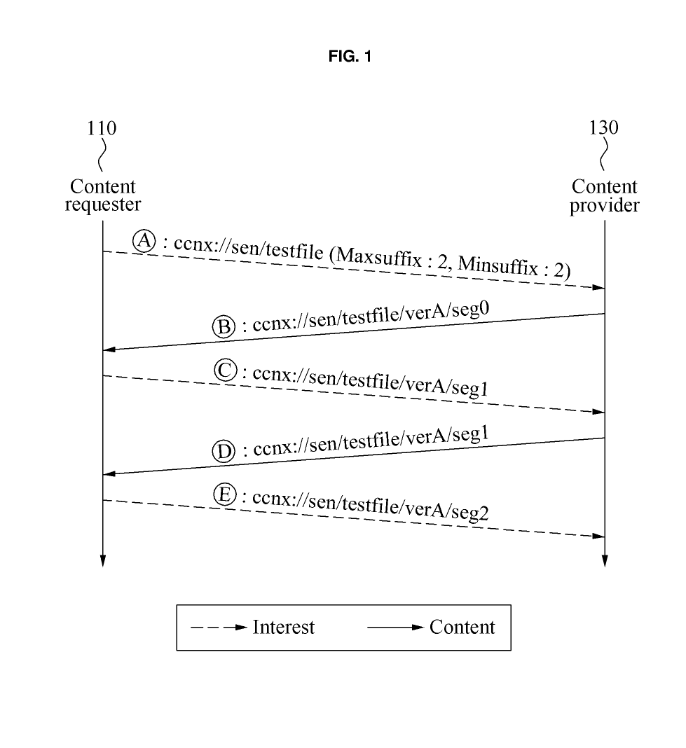

FIG. 1 illustrates an example of a process of forwarding a content in a CCN.

For content distribution in the CCN, each node may operate a content cache. When a segment of a content is forwarded, each node may store the segment in a respective content cache and forward the segment stored in the content cache in response to a request for the segment. Thus, a concentration of requests for the content on a node, for example, a server, may be distributed and data usage in a core network may be reduced.

Referring to FIG. 1, a node receives a content by forwarding a packet in the CCN.

In the CCN, the content requesting node may receive the latest version information of the content by the content provider forwarding the packet and subsequently, the node may request and receive a next segment of the content. In this case, an interest packet forwarded by the node may refer to a packet requesting a content segment, and a content packet may refer to a packet including the content segment. A content name included in each packet changes based on the content name requested by or included in a corresponding packet in a process of forwarding the packet.

When requesting a content in the CCN, a node may use a full name of the content or a partial name of the content, for example, a front portion of a content name, also referred to as a prefix. For example, a node may request only a prefix to obtain a control message, for example, latest version information, content list information, or routing information, and receive a partially matched content.

A content may be updated to a latest version by a content publisher.

Thus, as illustrated in FIG. 1, a content requester 110 may send an interest packet which is a message requesting a partial match to a content name, indicated as A, to obtain the latest version information on the named content. A header of the interest packet may include a number of maximum suffix components, for example, Maxsuffix: 2, or a number of minimum suffix components, for example, Minsuffix: 2, disposed at a rear portion of the name of the requested content, for example, “ccnx://sen/testfile.”In response to the request for the content, a content provider 130, for example, the content publisher or an intermediate node, may forward a first segment B of the latest version possessed by the content provider 130. Whether the content is of the latest version may be determined based on version information, for example, “verA/seg0,” included in a name of the first segment B included in the response packet.

Subsequently, the content requester 110 may request a next segment C, for example, “ccnx://sen/testfile/verA/seg1,” based on a name of the segment received from the content publisher or the intermediate node. The content publisher or the intermediate node may forward a segment D, for example, “ccnx://sen/testfile/verA/seg1,” precisely matching the name of the segment C. The process outlined in the foregoing may be repeated until a subsequent segment E and all the remaining segments are received by the content request 110.

During the aforementioned process, each of intermediate nodes may store forwarded content segments in their respective individual content cache. When an intermediate node receives a request for a content segment, the intermediate node may search the content cache of the intermediate node for the content segment and forward the found content segment. The intermediate node may forward a content or a segment of the content by requesting or searching for a matched content or a segment using not only a full name of the content, but also a portion of the name, for example, a prefix. This repetitive process of searching for content segments may result in a large load for the intermediate nodes processing and transmitting a numerous number of requests.

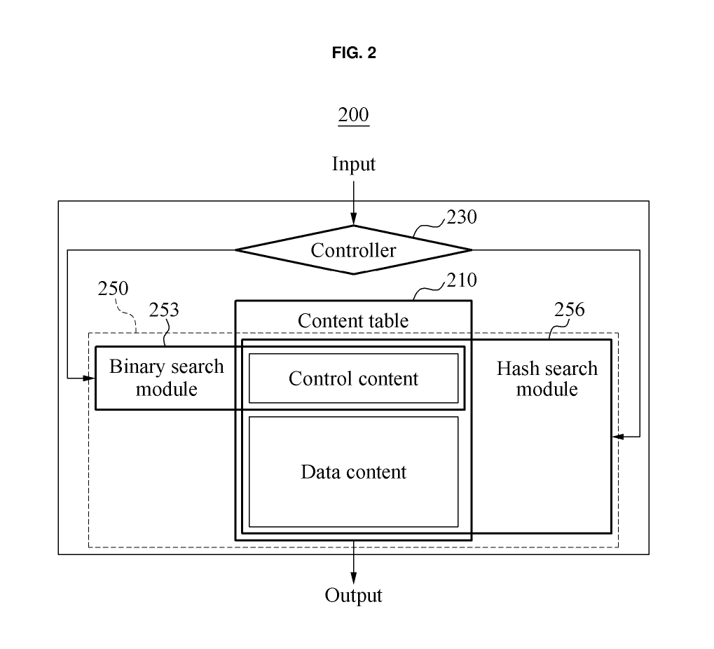

FIG. 2 is a diagram illustrating an example of a structure of a content cache 200 of a node.

Referring to FIG. 2, the node may include the content cache 200, and the content cache 200 may include a content table 210, a controller 230, and a searcher 250.

The content table 210 may store at least one segment of a content. Here, the at least one segment to be stored may be received from another node or may be originally stored in the node.

The controller 230 may determine a search algorithm based on a characteristic of a packet received from another node and apply the determined search algorithm to a search for the content. For example, the controller 230 may determine which of a data packet and a control packet correspond to a characteristic of the packet received from another node and determines the search algorithm based on a result of the determining. The controller 230 may be also referred to as a packet controller.

The searcher 250 may conduct a search of contents stored in the content table 210 using at least a portion of a content name, based on the search algorithm determined by the controller 230. The searcher 250 may include two search modules, a binary search module 253 and a hash search module 256, for example, to search the content table 210.

The binary search module 253 may search for the content using the at least a portion of the content name, based on a binary search algorithm.

The hash search module 256 may search for the content using a full content name, based on a hash search algorithm.

The binary search module 253 may search for control content segments based on partially matched names of contents stored in the content table 210. A number of components in the names of the contents found using the at least a portion of the content name may be predetermined.

The hash search module 256 may search for all segments including data content segments along with the control segments. The control content segments may include content segments used for direct control and content segments required for indirect control. Also, the data content segments may include contents or data requested directly by a content requester, along with information on the contents and the data.

Each of an interest packet or a content packet may include the control content segments or the data content segments.

The controller 230 may apply various methods to determine which of the data packet and the control packet correspond to the characteristic of the packet received from another node. For example, the controller 230 may determine the characteristic of the packet based on a segment number of the content. The controller 230 may analyze the packet received from another node, extract the segment number of the content requested by the packet, and determine which of the data packet and the control packet correspond to the packet based on the extracted segment number.

For example, when the extracted segment number is zero, indicating a first segment of the content, the controller 230 may determine that the packet is the control packet. Thus, the controller 230 may determine the packet to be the control packet based on version information included in a name of the first segment of the content.

The controller 230 may determine the characteristic of the packet based on a command indicator. For example, the controller 230 may extract the command indicator from the packet and determine which of the data packet and the control packet correspond to the packet based on the command indicator. A name of a segment of a content may include a command indicator indicating that the content corresponds to a request or a command. Thus, the controller 230 may extract the command indicator and determine the characteristic of the packet based on the command indicator. The command indicator may be provided in a form of, for example, an operation identification (OID). The controller 230 may determine the search algorithm based on the characteristic of the packet. When conducting a search of the contents stored in the content table 210 based on the search algorithm determined by the controller 230, the searcher 250 may use a partially matched content name or a fully matched content name.

Also, the controller 230 may determine the characteristic of the packet based on header information of the packet. For example, the controller 230 may extract information included in the header of the packet, and determine which of the data packet or the control packet corresponds to the packet based on the extracted information. The controller 230 may determine the characteristic of the packet based on a number of maximum suffix components or a number of minimum suffix components included in the header of the interest packet. For example only, when the number of the maximum suffix components and the number of the minimum suffix components in the header of the interest packet are, respectively, 2 and 2, the controller 230 may determine that the packet is a packet requesting a latest version based on the number of the components. The controller 230 may recognize the packet as a command requesting the latest version and responds with a first segment, for example, prefix/verA/seg0, of a latest version content stored in the content cache 200. The number of the maximum suffix components and the number of the minimum suffix components included in the header of the interest packet may be predetermined to be 2, respectively. In this instance, 2 indicates a command requesting the latest version, for example only.

Also, the controller 230 may determine the characteristic of the packet based on packet information additionally indicated in the header of the packet, for example, information indicating whether a partially matched content name is required.

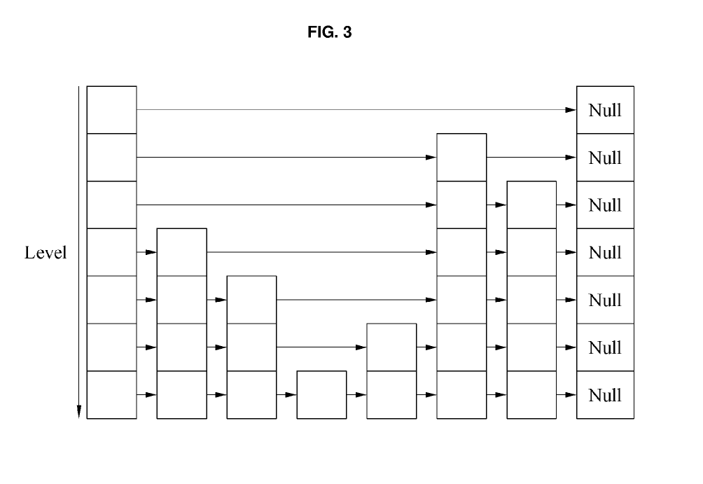

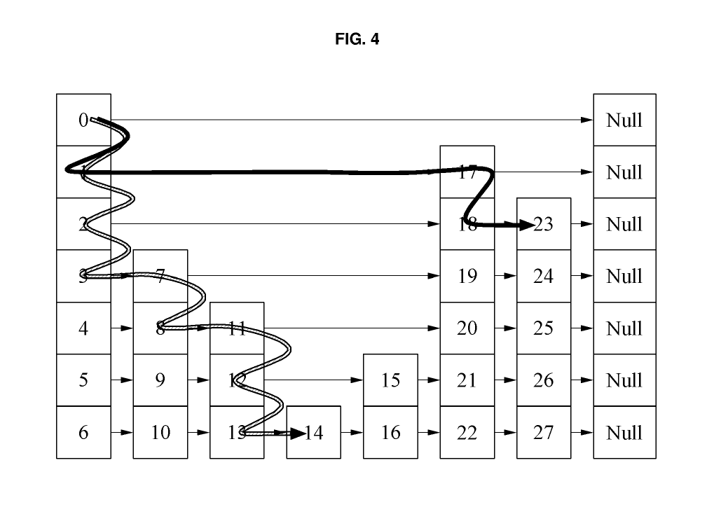

When the packet is determined to be the control packet, the controller 230 may determine, or select the search algorithm to be a binary search algorithm based on the partially matched content name. Such a binary search algorithm will be described in greater detail with reference to FIGS. 3 and 4.

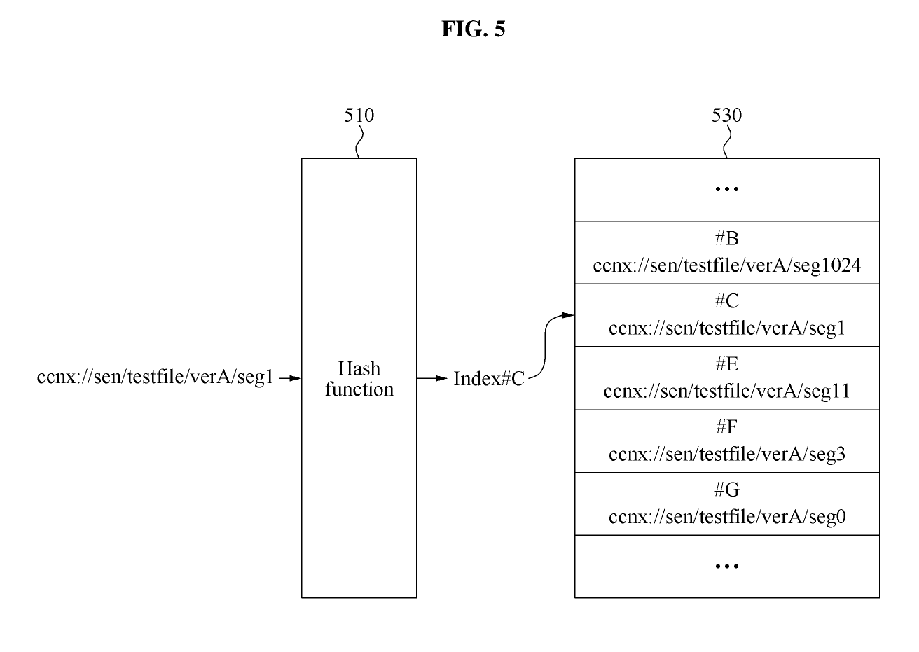

When the packet is determined to be the data packet, the controller 230 may determine or select the search algorithm that will be implemented a hash search algorithm based on a fully matched content name. Such a hash search algorithm will be described in greater detail with reference to FIG. 5.

FIG. 3 illustrates an example of a structure of a skip list used for a binary search algorithm.

Referring to FIG. 3, the skip list may be provided in a structure in which subjects having each level on the list are linked so as to form a linked list. Referring to the skip list, at a level having a larger depth or in a linked portion, data having a larger value may be stored.

A subject on the skip list may have several levels, and different subjects linked to one another may exist at each level. An increase in the depth of the level may be determined or set based on a random number, e.g., irrespective of a number of the subjects. A search algorithm applicable to the skip list will be further described with reference to FIG. 4.

FIG. 4 illustrates an example of a method of searching a skip list, such as the skip list of FIG. 3, based on a binary search algorithm.

Referring to FIG. 4, when a node receives a request to search for a content segment, the node compares a value of a subject indicated by a start pointer, for example, a segment number, to a value of the segment of the requested content, for example, a segment number.

When the value of the segment of the requested content is determined to be greater than the value of the subject indicated by the start pointer, the node may once again compare the value of the segment of the requested content to a value of a next subject linked to the subject previously compared.

When the value of the next subject is determined to be greater than the value of the segment of the requested content, the node may search for the segment of the requested content by leveling down from the previous subject.

The node finds an optimal subject by continuously comparing values as described in the preceding.

For example only, when the node searches for segment 14 and segment 23, the node performs the comparing a total of 15 times by comparing to segments 0, 1, 17, 2, 18, 3, 7, 19, 8, 11, 20, 12, 15, 13, and 14 stored in the skip list to find the segment 14, and the node performs the comparing a total of 5 times by comparing to segments 0, 1, 17, 18, and 23 stored in the skip list to find the segment 23.

This example method of searching the skip list indicates a performance of an averaged log N times of conducting a search. When comparing values of the segments using the skip list in the CCN, a node may perform the comparing only with a length of a name of a requested content. Thus, the node may obtain a content segment closest to the name of the requested content. Also, the node may additionally compare an additional matching request, for example, a number of components to be additionally linked, indicated in the header of the packet requesting the content segment and enable the content name to be partially matched.

FIG. 5 illustrates an example of a hash search algorithm.

Referring to FIG. 5, a node may use a hash function 510 to search for a content segment. The node may obtain an index of a hash table 530 by performing the hash function 510 in which a name of the content segment is used as a key value. Also, the node brings the content segment using the obtained index. For example only, a name “ccnx://sen/testfile/verA/seg1” of a content segment requested by the node may be the key value of the hash function 510. The node may perform the hash function 510 using the key value of the hash function 510 as an input value and obtain the index value, for example, index #C, of the hash table 530. The index #C may indicate a position of the hash table 530 and thus, the node may immediately find the requested segment stored in the hash table 530.

In general, searching the skip list based on a binary search algorithm may be accomplished with a relatively rapid search speed. However, using the binary search algorithm may be slower in comparison to the hash function search method, for example, which may obtain a result by conducting a search only once. Thus, the binary search algorithm and the hash search algorithm may be used in combination, as necessary.

In general, when a partial matching of a content name is required, or only required, in the CCN, it may be to support a control content, for example, a control and a command, rather than a data content. For example, a partially matched content name may be required, or only required, to perform version resolving to obtain latest version information when a node is not aware of version information of a corresponding content and to support the control or the command, for example, a name enumeration command, to obtain a list to show which contents matching a particular prefix of the content name exist. Also, the node may receive an exact content or data through a request for a full name matching for transmitting a pure content or data.

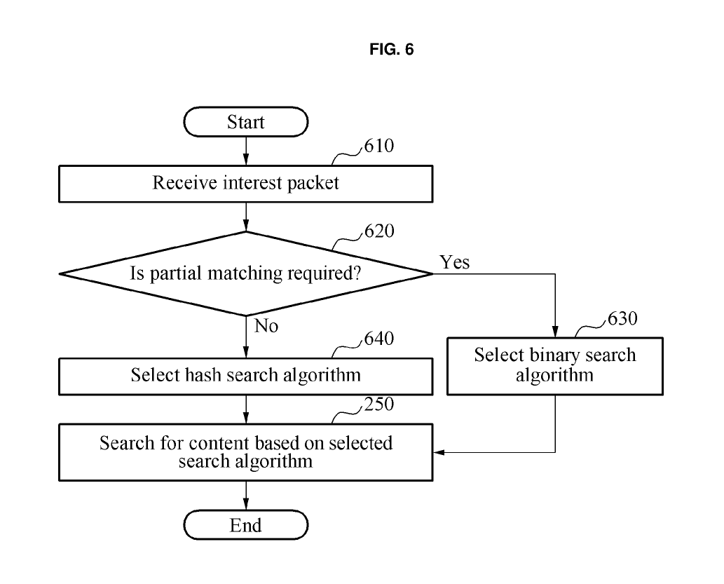

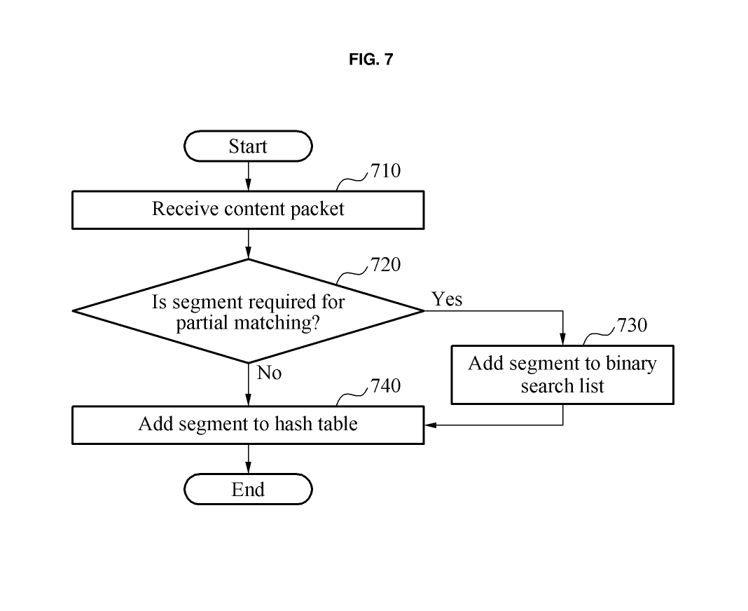

FIGS. 6 and 7, respectively, illustrate examples of operation methods of a node when the node receives an interest packet requesting a content segment and when the node receives a content packet including the content segment.

FIG. 6 is a flowchart illustrating an example of an operation method of a node processing method for an interest packet. FIG. 6 illustrates that the node receives the interest packet requesting a content segment. Here, the interest packet may include a data content or a control content.

Thus, in operation 610, the node receives the interest packet from another node. In operation 620, the node determines whether the interest packet received in operation 610 requires a partially matched content name. Whether the interest packet requires the partially matched content name may be determined based on a characteristic of the interest packet. For example, when the characteristic of the interest packet is determined to be a control packet, the node may determine that the interest packet requires the partially matched content name. When the characteristic of the interest packet is determined to be a data packet, the node may determine that the interest packet requires a fully matched content name.

The node may determine the characteristic of the interest packet based on a content name included in the interest packet or header information of the interest packet and determine whether the interest packet requires the partially matched content name based on a result of the determining.

Based on a result of the determining in operation 620, the node may select one of a binary search algorithm and a hash search algorithm and search for a matched content.

For example, when the interest packet is determined to require partial matching of the content name in operation 620, the node may select the binary search algorithm in operation 630 and search for the matched content using the binary search algorithm in operation 650.

When the interest packet is determined to require the fully matched content name in operation 620, the node may select the hash search algorithm in operation 640 and search for the matched content using the hash search algorithm in operation 650.

In operation 650, the node may perform a hash function by determining the content name to be a key value and obtaining an index value of a hash table based on a result of performing the hash function. Also, the node may search a content table for the matched content based on the obtained index value of the hash table.

The node may forward the found content to a node requesting the content, e.g., the node that sent the interest packet, or an intermediate node.

FIG. 7 is a flowchart illustrating an example of a node processing method for a content packet in a CCN.

FIG. 7 illustrates that the node receives the content packet including a content segment. Here, the content packet may include a data content or a control content.

Thus, in operation 710, the node may receive the content packet from another node.

In operation 720, the node may determine whether a segment of the content packet received in operation 710 is required for partial matching of a content name. In operation 720, the node may determine whether the segment is at least required for the partial matching of the content name based on a name of the packet or header information. For example only, when information included in the header of the content packet indicates a segment number of zero, the node may determine that the segment is required for the partial matching. Also, the node may add, to the header of the content packet, an additional field supporting the partial matching.

Based on a result of the determining in operation 720, the node may add the segment of the content packet to at least one of a binary search list and a hash table. For example, when the segment of the content packet is determined to be required for the partial matching of the content name in operation 720, the node may add the segment to the binary search list in operation 730.

When the segment of the content packet is determined not to be required for the partial matching of the content name in operation 720, the node may add the segment to the hash table in operation 740. The node may support a hash search for all content segments.

For example, the node may store a minimum number of content segments in the binary search list such as a skip list and perform the partial matching of the content name. Here, the content segment may also be added to the hash table and thus, may be searched when a full name request is received. When the content packet arrives and the segment of the content packet is not a segment necessarily required for the partial matching of the content name, the segment may be immediately added to the hash table, for example.

In a CCN, all nodes on a routing path may search individual content caches every time each of the nodes receives a request for a content segment in a process of forwarding a content for content distribution. Using only the binary search algorithm, for example, the skip list, which is always relatively slow, may degrade performance of an overall networking protocol.

In an example, a search algorithm based on the hash function may be used to search content segments, excluding a very few number of content segments for control. For example only, when a file with a size of 100 megabytes (MBs) is forwarded and a size of each content segment is 4 kilobytes (KBs), a total number of content segments may be 26000. Accordingly, a first segment may be processed as a control packet to find content version information, and the remaining 25999 segments may be processed as a data packet, for example only. In this case, a relatively slow binary search algorithm may be used to search for the first segment for only one control, and a relatively fast hash search algorithm may be used to search for the remaining segments for data forwarding.

Also, the node may add only a minimum number of segments required for the partial matching of the content name to the binary search list. Thus, in this case, the binary search time, which may be greatly affected by a number of lists stored in the skip list, may be greatly reduced when compared to a method of adding all content segments to a list. In this example, when a number of intermediate nodes increases, a greater number of contents may be shared and thus, performance may be improved.

The apparatus and the units described herein according to one or more embodiments may be implemented using hardware components, software components, or a combination thereof. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired, and is embodied in/on a non-transitory computer or processer readable medium. Software and data may be embodied permanently or temporarily in any type of non-transitory machine, component, computer storage medium or device. The software may also be distributed over network coupled computer systems so that the software is stored and executed in a distributed fashion.

Again, the method described herein according to one or more embodiments may be implemented by non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

While this disclosure includes specific examples, it will be apparent to one of ordinary skill in the art that various changes in form and details may be made in these examples without departing from the spirit and scope of the claims and their equivalents. For example, suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. A node, comprising:
a content table configured to store a segment of a content in a memory;
a controller configured to select a search algorithm, from among plural search algorithms, to search for a content requested by a packet received from another node, based on a determined characteristic of the packet received from another the other node; and
a searcher configured to search contents stored in the content table for at least one portion of a content name of the content for the packet using the selected search algorithm.

2. The node of claim 1, wherein the controller is configured to determine which of a data packet and a control packet corresponds to the characteristic of the packet, and to select the search algorithm from among the plural search algorithms based on a result of the determining of which of the data packet and the control packet corresponds to the characteristic of the packet.

3. The node of claim 2, wherein the controller is configured to analyze the packet, to extract a segment number of the content requested by the packet, and to determine which of the data packet and the control packet corresponds to the characteristic of the packet based on the extracted segment number, as the determined characteristic.

4. The node of claim 2, wherein the controller is configured to extract a command indicator from the packet and to determine which of the data packet and the control packet corresponds to the characteristic of the packet based on the extracted command indicator, as the determined characteristic.

5. The node of claim 2, wherein the controller is configured to extract information from a header of the packet, and to determine which of the data packet and the control packet corresponds to the characteristic of the packet based on the extracted information, as the determined characteristic.

6. The node of claim 2, wherein, the controller is configured to select a binary search algorithm, from among at least the binary search algorithm and a hash search algorithm, that searches for a partial match to the content name when the packet is determined to be the control packet.

7. The node of claim 2, wherein the controller is configured to select a hash search algorithm, from among at least a binary search algorithm and the hash search algorithm, that searches for a full match to the content name when the packet is determined to be the data packet.

8. The node of claim 1, wherein the searcher comprises:
a binary search module; and
a hash search module, and
wherein the binary search module is configured to search for requested content using at least a portion of a corresponding content name using a binary search algorithm, and the hash search module is configured to search for requested content using a full content name of a corresponding content name using a hash search algorithm.

9. The node of claim 8, wherein, with the binary search module, a number of components, controlling of an extent of the portion of the corresponding content name that is searched for using the binary search algorithm, is preset.

10. A node method, the method comprising:
receiving an interest packet from another node;
determining, based on a determined characteristic of the interest packet, which of a partial match and a full match to a content name is to be used to control an extent of a searching for content for the received interest packet;
selecting, based on a result of the determining of which of the partial match and the full match is to be used to control the extent of the searching, a search algorithm between a binary search algorithm and a hash search algorithm; and
searching for one or more matching content for the content for the received interest packet using the selected search algorithm.

11. The method of claim 10, wherein the determining of which of the partial match and the full match is to be used to control the extent of the searching further comprises:
determining whether a search for requested content of the interest packet requires only the partial match to the content name based on the content name identified in the interest packet or header information of the interest packet.

12. The method of claim 10, wherein the searching for one or more matching content comprises:
selecting the search algorithm to be the binary search algorithm when the interest packet is determined to only require the partial match to the content name.

13. The method of claim 10, wherein the searching for a one or more matching content comprises:
selecting the search algorithm to be the hash search algorithm when the interest packet is determined to require a full match to the content name.

14. The method of claim 13, wherein when the search algorithm is selected to be the hash search algorithm, the searching further comprises:
performing a hash function by determining the content name to be a key value;
obtaining an index value of a hash table based on a result of the performing of the hash function; and
searching for a matched content based on the index value.

15. The method of claim 10, further comprising:
outputting a retrieved content after the searching, including providing the retrieved content to an intermediate node or the other node.

16. A node method, the method comprising:
receiving by a node a content packet from another node;
determining whether a segment of the content packet is required for only a partial match to a content name indicated by the received content packet; and
adding the segment to a selected one or more of a binary search list and a hash table based on a result of the determining.

17. The method of claim 16, wherein the determining of whether the segment of the content packet is required for only a partial match to the content name is based on the content name in the content packet or header information of the content packet.

18. The method of claim 16, wherein, when the segment is determined to be required for only the partial match to the content name, the adding of the segment comprises selecting the binary search list and the hash table to add the segment to.

19. The operation method of claim 16, wherein the segment is selected to be added to the hash table when the segment is determined to not be required for only the partial match to the content name.

20. A non-transitory computer-readable storage medium comprising instructions to control a processing device to implement a node method, the method including:
receiving an interest packet from another node;
determining, based on a determined characteristic of the interest packet, which of a partial match and a full match to a content name is to be used to control an extent of a searching for content for the received interest packet;
selecting, based on a result of the determining of which of the partial match and the full match is to be used to control the extent of the searching, a search algorithm between a binary search algorithm and a hash search algorithm; and
searching for one or more matching content for the content for the received interest packet sing the selected search algorithm.

21. The node apparatus of claim 1, wherein the content table in the memory, the controller, and the searcher are included in a content cache of the node apparatus.

22. The node apparatus of claim 1, wherein the node apparatus is a content centric networking (CCN) node, where plural content stored by the node apparatus are respectively externally addressable based on respective content names of the plural content through a full name and a prefix of the full name, and the packet is a CCN packet.
